(19) United States
(12) Patent Application Publication
(10) Pub. No.: US 2026/0229733 A1
(43) Pub. Date: Aug. 6, 2026

(54) SECONDARY BATTERY

(71) Applicant: SAMSUNG SDI CO., LTD., Yongin-si (KR)

(72) Inventor: Jun Sik KIM, Yongin-si (KR)

(21) Appl. No.: 19/282,539

(22) Filed: Jul. 28, 2025

(30) Foreign Application Priority Data
Feb. 6, 2025 (KR) 10-2025-0014970

(51) Int. Cl. H01M 50/557; B60L 50/64; H01M 50/105; H01M 50/178; H01M 50/46; H01M 50/533; H01M 50/55

(52) U.S. Cl. CPC H01M 50/557; H01M 50/105; H01M 50/178; H01M 50/46; H01M 50/533; H01M 50/55; B60L 50/64; H01M 2220/20

(57) ABSTRACT

A secondary battery includes a case, and an electrode assembly accommodated in the case. The electrode assembly includes a stack that includes of first electrode plates each including a first electrode tab, a second electrode plates each including a second electrode tab, and separators each of which is interposed between one of the first electrode plates and one of the second electrode plate. An L-shaped first strip terminal is bonded to the first electrode tab, with a portion being exposed to the outside of the case. An L-shaped second strip terminal is boned to the second electrode tab, with a portion being exposed to the outside of the case.

### CROSS-REFERENCE TO RELATED APPLICATION

This application claims priority to and the benefit of Korean Patent Application No. 10-2025-0014970 filed on Feb. 6, 2025, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable small electronic devices, such as smart phones, feature phones, notebook(laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not constitute related (or the prior) art.

### SUMMARY

Aspects of some embodiments of the present disclosure provide a secondary battery in which positions of an electrode tab of an electrode assembly and an external terminal are stable.

These and other aspects and features of the present disclosure will be described in or will be apparent from the following description of embodiments of the present disclosure.

According to some embodiments, a secondary battery includes a case; an electrode assembly accommodated in the case, the electrode assembly including a stack of first electrode plates each of which includes a first electrode tab, second electrode plates each of which includes a second electrode tab, and separators each of which is interposed between one of the first electrode plates and one of the second electrode plates; an L-shaped first strip terminal that is bonded to the first electrode tab, with a portion of the first strip terminal being exposed to outside of the case; and an L-shaped second strip terminal that is boned to the second electrode tab, with a portion of the second strip terminal being exposed to outside of the case.

The first strip terminal may include a first bonding part bonded to the first electrode tab and a first extension part extending vertically from the first bonding part, and the second strip terminal may include a second bonding part bonded to the second electrode tab and a second extension part extending vertically from the second bonding part.

The first bonding part may be disposed perpendicular to a longitudinal direction of the first electrode tab, and the second bonding part may be disposed perpendicular to a longitudinal direction of the second electrode tab.

The first strip terminal and the second strip terminal may be symmetrically disposed with respect to a longitudinal center line of the electrode assembly.

The first bonding part and the second bonding part may be disposed to face the same direction.

A distance between the first strip terminal and the second strip terminal may be greater than a distance between the first electrode tab and the second electrode tab.

The first bonding part and the second bonding part may be disposed to face different directions.

A distance between the first strip terminal and the second strip terminal may be less than or greater than a distance between the first electrode tab and the second electrode tab.

The first bonding part and the second bonding part may be disposed to face each other.

A distance between the first strip terminal and the second strip terminal may be greater than a distance between the first electrode tab and the second electrode tab.

The first strip terminal and the second strip terminal may be disposed to be more towards one side with respect to a longitudinal center line of the electrode assembly.

If the first strip terminal and the second strip terminal are disposed more towards the one side with respect to the longitudinal center line of the electrode assembly, a length of each of the first bonding part and the second bonding part may be greater than a length of each of the first boding part and the second bonding part if the first strip terminal and the second strip terminal are disposed symmetrically with respect to the longitudinal center line of the electrode assembly.

The first bonding part may include a first surface extending vertically from an end of the first extension part, a second surface parallel to the first surface, and a connection surface connecting the first surface to the second surface, and the second bonding part may include a first surface extending vertically from an end of the second extension part, a second surface parallel to the first surface, and a connection surface connecting the first surface to the second surface.

The connection surface may be perpendicular to the first surface and the second surface.

The connection surface may have a curved shape.

The first bonding part may include a first surface extending vertically from an end of the first extension part and a second surface facing the first surface, and the second bonding part may include a first surface extending vertically from an end of the second extension part and a second surface facing the first surface.

The first surface and the second surface may have an acute angle with respect to each other.

The first strip terminal may include a connection tab bonded to the first electrode tab, and a first extension part disposed perpendicular to the connection tab and coupled to the connection tab, and the second strip terminal may include a connection tab bonded to the second electrode tab, and a second extension part disposed perpendicular to the connection tab and coupled to the connection tab.

The connection tabs of the first and second terminals may each have one of straight, triangular, semicircular, and circular cross-sections.

The secondary battery may further include an insulating member provided in an area between the first strip terminal and the case and an insulating provided in an area between the second strip terminal and the case.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to embodiments;

FIG. 2 is a schematic projective view of the secondary battery illustrated in FIG. 1;

FIG. 3 is a plan view of a terminal structure according to embodiments;

FIG. 4 is a plan view of a terminal structure according to another embodiment;

FIGS. 5 to 7 are plan views of a terminal structure according to another embodiment;

FIGS. 8 and 9 are plan views of a terminal arrangement of a typical secondary battery;

FIGS. 10 to 13 are plan views of a terminal arrangement according to embodiment;

FIG. 14 is a schematic view comparing an exothermic reaction of an electrode assembly if the terminal is disposed at a center;

FIG. 15 is a schematic view comparing an exothermic reaction of an electrode assembly if the terminal is disposed at one side; and

FIGS. 16 and 17 are partial cross-sectional views of the secondary battery according to embodiments.

FIGS. 18 and 19 are perspective views showing a battery pack including an exemplary secondary battery according to the present invention.

FIGS. 20 and 21 are perspective and side views of a vehicle including an exemplary battery pack according to the present invention.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

Hereinafter, a secondary battery according to embodiments will be described in detail with reference to the accompanying drawings.

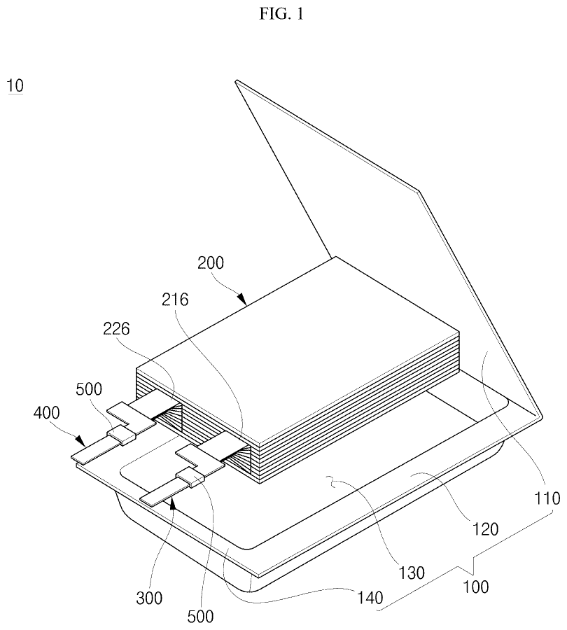

Referring to FIGS. 1 to 13, a secondary battery 10 according to embodiments may be a pouch-type battery. The secondary battery 10 may include a case 100, an electrode assembly 200, a first strip terminal 300, a second strip terminal 400, a first insulating member, and a second insulating member 500. In some embodiments, the secondary battery 10 may further include a connection tab 600 and an insulating tape 700 in some embodiments.

Referring to FIG. 1, the case 100 may accommodate the electrode assembly 200 together with an electrolyte. The case 100 may be referred to as a pouch, a pouch exterior, a pouch case, a laminate exterior, etc. The case 100 may be provided by folding a plate-shaped structure so that the exteriors face each other to provide a cover 110 and a recess 130. The recess 130 may be provided by pressing or drawing one surface of the exterior. The recess 130 may form an accommodation space in which the electrode assembly is accommodated. A portion in which the recess 130 is not provided may be the cover 110. An edge of one surface having the recess 130 may be a sealing part 120 that is sealed with the cover 110. Before sealing the sealing part 120, electrode tabs 216 and 226 and the strip terminals 300 and 400 may be electrically connected, and the strip terminals 300 and 400 may be exposed outside of the case 100. A partial area of the sealing part 120 through which the strip terminals 300 and 400 are exposed may be separately referred to as a terrace part 140. A remaining area of the sealing part excluding the terrace part 140 may be referred to as a side sealing part. After the strip terminals 300 and 400 are connected to the electrode tabs 216 and 226, the sealing part 120 may be sealed. That is, with the electrode assembly 200 is accommodated in the recess 130, the sealing part 120 may be coupled to the cover 110 through thermal fusion or the like in. In some embodiments, an adhesive/adhesive layer/adhesive member, etc. may be provided between the cover 110 and the electrode assembly 200 to fix the electrode assembly 200.

Referring to FIGS. 1, 2, 14, and 15, the electrode assembly 200 may include a first electrode plate 210, a second electrode plate 220, and a separator 230. The electrode assembly 200 may include or be referred to as an electrode group, an electrode body, or a jelly roll. The electrode assembly 200 may have a shape in which the separator 230, the first electrode plate 210, the separator 230, the second electrode plate 220, the separator 230, etc. are sequentially stacked. In other embodiments, the electrode assembly 200 may be in the form of a Z-stack in which the first electrode plate 210 and the second electrode plate 220 are provided to opposite sides of the separator 230 that is bent in a Z shape. In still other embodiments, the electrode assembly 200 may be in a wound form that is wound with the separator 230 is interposed between the first electrode plate 210 and the second electrode plate 220.

The first electrode plate 210 may be either a negative electrode plate or a positive electrode plate. The first electrode plate 210 may include a first base material 212 in the form of a metal plate, a first active material layer 214 provided on at least one surface of the first base material 212, and a first non-coating portion where the first active material layer 214 is not provided. The first non-coating portion may be notched in a predetermined shape to provide a first electrode tab 216. In some embodiments, a separate tab may be coupled to the first non-coating portion. A plurality of first electrode tabs 216 may be provided, which may be referred to as a multi-tap structure. After being gathered and integrated, the first electrode tabs 216 may be electrically connected to the first strip terminal 300. In some embodiments, the first electrode tab 216 may be disposed in one direction of the electrode assembly 200. The arrangement direction of the first electrode tab 216 may correspond to a winding axis direction of the electrode assembly 200.

For example, the first electrode plate 210 may function as a positive electrode. The first base material 212 may include aluminum foil, and the first active material layer 214 may include transition metal oxide. Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The current collector may be aluminum (Al) but is not limited thereto.

The second electrode plate 220 may be the other of a negative electrode plate and a positive electrode plate (i.e., opposite polarity to the first electrode plate 210). The second electrode plate 220 may include a second base material 222 in the form of a metal plate, a second active material layer 224 provided on at least one surface of the second base material 222, and a second non-coating portion where the second active material layer 224 is not provided. The second non-coating portion may be notched in a predetermined shape to provide a second electrode tab 226. In some embodiments, a separate tab may be attached to the second non-coating portion. A plurality of second electrode tabs 226 may be provided in plurality, which may be referred to as a multi-tap structure. After being gathered and integrated, the second electrode tabs 226 may be electrically connected to the second strip terminal 400. In some embodiments, the second electrode tab 226 may be disposed in one direction of the electrode assembly 200. The arrangement direction of the second electrode tab 226 may be the same as the arrangement direction of the first electrode tab 216, with the second electrode tab 226 spaced apart from the first electrode tab 216.

The second electrode plate 220 may function as a negative electrode. The second base material 222 may include copper or nickel foil, and the second active material layer 224 may include a carbon-based material, Si, Sn, tin oxide, a tin alloy complex, transition metal oxide, lithium metal nitrite, or metal oxide. The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator 230 may be interposed between the first electrode plate 210 and the second electrode plate 220 to prevent short circuit between the first electrode plate 210 and the second electrode plate 220. The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The electrolyte solution for a rechargeable lithium battery may include a non-aqueous organic solvent and a lithium salt.

The non-aqueous organic solvent may serve as a medium for transmitting ions taking part in the electrochemical reaction of a battery. The non-aqueous organic solvent may be a carbonate-based, ester-based, ether-based, ketone-based, or alcohol-based solvent, an aprotic solvent, or a combination thereof, and may be used alone or in combination of two or more types.

Additionally, when using a carbonate-based solvent, a cyclic carbonate and a chain carbonate may be used in combination.

The first strip terminal 300 and the second strip terminal 400 may be electrically connected to the first electrode tab 216 and the second electrode tab 226, respectively. In more detail, the plurality of first electrode tabs 216 may be gathered and integrated, and then the first strip terminal 300 may be bonded. Similarly, the plurality of second electrode tabs 226 may be gathered and integrated, and then the second strip terminal 400 may be bonded. In some embodiments, the bonding may be made by welding. The gathered and integrated electrode tabs may also be bonded to the strip terminal after the welding. A bonding area of the first electrode tab 216 and the first strip terminal 300 and a bonding area of the second electrode tab 226 and the second strip terminal 400 are indicated as reference symbol W in the drawings. In the state in which the first strip terminal 300 and the second strip terminal 400 are bonded to the first electrode tab 216 and the second electrode tab 226, the first insulating member and the second insulating member 500 may be provided, and then sealing may be performed.

The first insulating member and the second insulating member 500 may be insulating tapes attached to both surfaces of the first strip terminal 300 and the second strip terminal 400. In some examples, the first insulating member and the second insulating member 500 may be polymer films that are fixed to the first strip terminal 300 and the second strip terminal 400 by the thermal fusion. The first insulating member and the second insulating member 500 may prevent the short circuit between the first and second strip terminals 300 and 400 and the case 100 from occurring. The first insulating member and the second insulating member 500 may be provided separately and then attached to the first strip terminal 300 and the second strip terminal 400. In some embodiments, a single connected insulating member may be attached to both the first strip terminal 300 and the second strip terminal 400.

Hereinafter, the structures of the first strip terminal 300 and the second strip terminal 400 will be described in more detail.

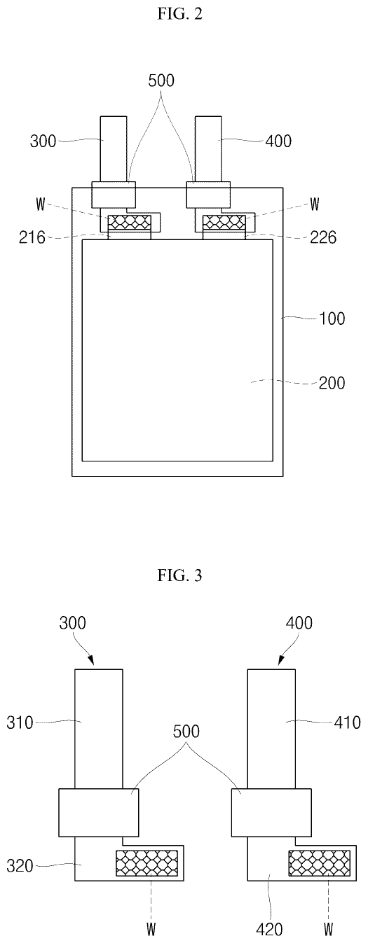

Referring to FIGS. 2 and 3, the first strip terminal 300 may have an approximately ‘L’ shape as viewed from above. The first strip terminal 300 may be bonded to the first electrode tab 216 and then electrically connected the first electrode tab 216. In some embodiments, the first strip terminal 300 may be made of the same material as the first electrode tab 216. The bonding method may be ultrasonic welding or laser welding. The first strip terminal 300 may include a first extension part 310 and a first bonding part 320. The first extension part 310 may be provided in the form of a straight plate, and one end of the first extension part 310 may be exposed outside of the case 100. The first insulating member 500 may be provided on the first extension part 310. The first bonding part 320 may have a plate shape and may extend vertically from the first extension part 310. With respect to the first electrode tab 216, the first bonding part 320 may be perpendicular to a longitudinal direction of the first electrode tab 216. And the first extension part 310 may be perpendicular to a longitudinal direction of the first bonding part 320. In an example, the first extension part 310 and the first bonding part 320 may be provided in one body, with the first electrode tab 216 may be bonded to the first bonding part 320. As noted above, the bonding area is indicated as reference symbol W in the drawing. The bonding area W may be provided along a longitudinal direction of the first bonding part 320, with the bonding area W provided on at least a portion of the first boding part 320.

The second strip terminal 400 may have an approximately ‘L’ shape as viewed from above. For example, the second strip terminal 400 may be bonded to the second electrode tab 226 and then be electrically connected to the second electrode tab 226. In some embodiments, the second strip terminal 400 may be made of the same material as the second electrode tab 226. The bonding method may be ultrasonic welding or laser welding. The second strip terminal 400 may include a second extension part 410 and a second bonding part 420. The second strip terminal 400 may have the same shape as the first strip terminal 300. The bonding area W of the second strip terminal 400 may also be provided along a longitudinal direction of the second bonding part 420, with the bonding area W provided on at least a portion of the second bonding part 420.

The first extension part 310 and the first bonding part 320 may be provided separately and then be connected to each other through bonding. Similarly, the second extension part 410 and the second bonding part 420 may also be provided separately and then be connected to each other through bonding.

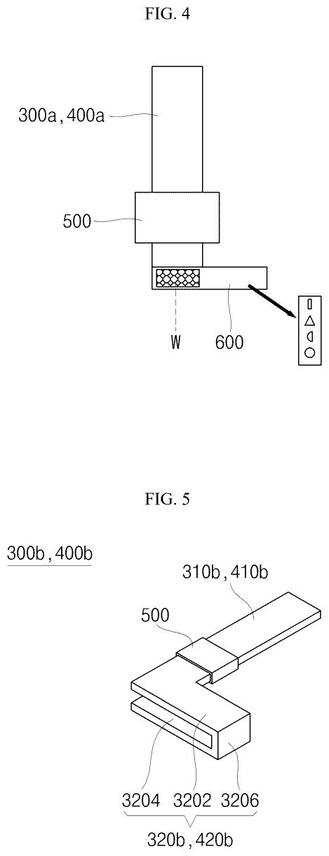

As illustrated in FIG. 4, the first strip terminal 300a and the second strip terminal 400a may be provided with only the first and second extension parts 310 and 410, and a separate connection tab 600 may be provided. The connection tab 600 may have a straight plate shape that is the same as each of the first and second bonding parts 320 and 420. In some embodiments, as illustrated in FIG. 4, the connection tab 600 may have a bar shape having, for example, a straight, triangular, semicircular, or circular cross-section. Even if the first strip terminal 300 and the second strip terminal 400 have the shapes of FIG. 4, the first strip terminal 300 and the second strip terminal 400 may appear to be the same as the strip terminal of FIG. 3 as viewed from above.

As illustrated in FIGS. 5 to 7, the first strip terminal 300 and the second strip terminal 400 may have first and second bonding parts 320b, 320c, 320d, 420b, 420c, and 420d, which have a three-dimensional shape.

Referring to FIG. 5, the first strip terminal 300b and the second strip terminal 400b may include first and second extension parts 310b and 410b, each of which has a straight plate shape. The terminals 300b and 400b may also include first and second bonding parts 320b and 420b integrated with the first and second extension parts 310b and 410b and are bent in the shape of the letter “C”. In more detail, the first and second bonding parts 320b and 420b may include a first surface 3202 extending vertically from ends of the first and second extension parts 310b and 410b, a second surface 3204 parallel to the first surface 3202, and a connection surface 3206 connecting the first surface 3202 to the second surface 3204. The connection surface 3206 may be perpendicular to the facing first surface 3202 and second surface 3204. The first electrode tab 216/the second electrode tab 226 may be inserted and bonded between the first surface 3202 and the second surface 3204.

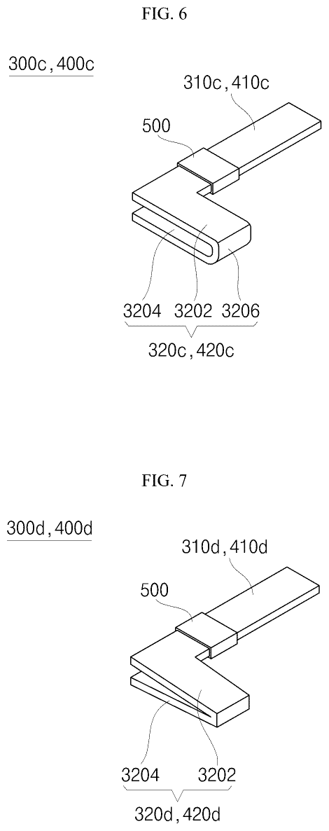

Referring to the embodiment depicted in FIG. 6, the first strip terminal 300c and the second strip terminal 400c have the same shape as the first strip terminal 300b and the second strip terminal 400b of FIG. 5, but the connection surface 3206 connecting the first surface 3202 and the second surface 3204, which face each other, has a curved shape. The first strip terminal 300c and the second strip terminal 400c of FIG. 6 may also be bonded by inserting the first electrode tab 216/the second electrode tab 226 between the first surface 3202 and the second surface 3204, which face each other.

Referring to FIG. 7, the first strip terminal 300d and the second strip terminal 400d may be disposed so that the first and second bonding parts 320d and 420d have a ‘V’-shaped cross section. In some embodiments, the first and second bonding parts 320d and 420d may have a first surface 3202 extending vertically from the ends of the first and second extension parts 310d and 410d, and a second surface 3204 connected to form an acute angle with respect to the first surface 3202. The first strip terminal 300d and the second strip terminal 400d of FIG. 7 may also be bonded by inserting the first electrode tab 216/the second electrode tab 226 between the first surface 3202 and the second surface 3204, which are formed in the ‘V’ shape.

Even though the first strip terminals 300b to 300d and the second strip terminals 400b to 400d are formed in different the shapes depicted in FIGS. 5 to 7, as viewed from above the first strip terminals 300b to 300d and the second strip terminals 400b to 400d may appear to be the same as the strip terminal of FIG. 3. In the first strip terminals 300b to 300d and the second strip terminals 400b to 400d, which have the different three-dimensional shapes, the bonding area for boding to the electrode tabs may increase, and bonding strength may be improved.

The first strip terminal and the second strip terminal according to the foregoing various embodiments may be arranged in various manners depending on the direction of the first and second bonding parts (hereinafter, the first and second bonding parts are referred to as in the structure depicted in FIG. 3).

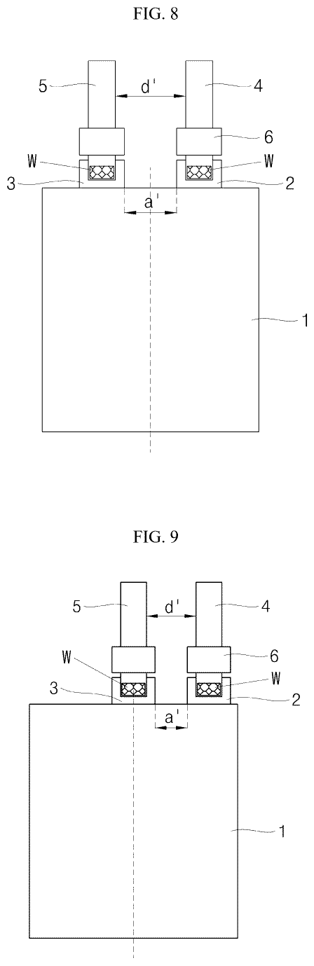

FIG. 8 illustrates a typical terminal arrangement in the form of a straight line. Note, because the strip terminal serves to be connected to outside, it is also referred to as an external terminal, and, in some embodiments, the electrode tab is also referred to as an internal terminal. Referring to FIG. 8, in the typical secondary battery, the electrode assembly 1 may include a negative electrode tab 2 and a positive electrode tab 3, each of which has a straight shape. A negative strip terminal 4 and a positive strip terminal 5 in the shape of a line are connected to each of the negative electrode tab 2 and the positive electrode tab 3 by bonding. The negative electrode strip terminal 4 and the positive electrode strip terminal 5 may be disposed towards a center of the electrode assembly 1 (based on a center line of FIG. 8). An insulating material 6 may be disposed at a portion that is in contact with the case 100. In some embodiments, a distance between the negative electrode tab 2 and the positive electrode tab 3 may be indicated as a′, and a distance between the negative electrode strip terminal 4 and the positive electrode strip terminal 5 may be indicated as d′.

As illustrated in FIG. 9, in the typical secondary battery, the electrode assembly 1 may include a negative electrode tab 2 and a positive electrode tab 3, which are positioned more towards one side (e.g., the right side as shown in FIG. 9). A negative strip terminal 4 and a positive strip terminal 5 in the shape of a line are connected to each of the negative electrode tab 2 and the positive electrode tab 3 by bonding. In some embodiments, the negative electrode strip terminal 4 and the positive electrode strip terminal 5 may also be disposed at one side with respect to the center line in FIG. 9. And a distance between the negative electrode tab 2 and the positive electrode tab 3 may be indicated as a′, and a distance between the negative electrode strip terminal 4 and the positive electrode strip terminal 5 may be indicated as d′.

When using an electrode tab according to embodiments of the present disclosure, even if the distance between the strip terminals is the same as in FIGS. 8 and 9, the distance between the electrode tabs may be secured to be greater than the distance depicted in FIG. 8.

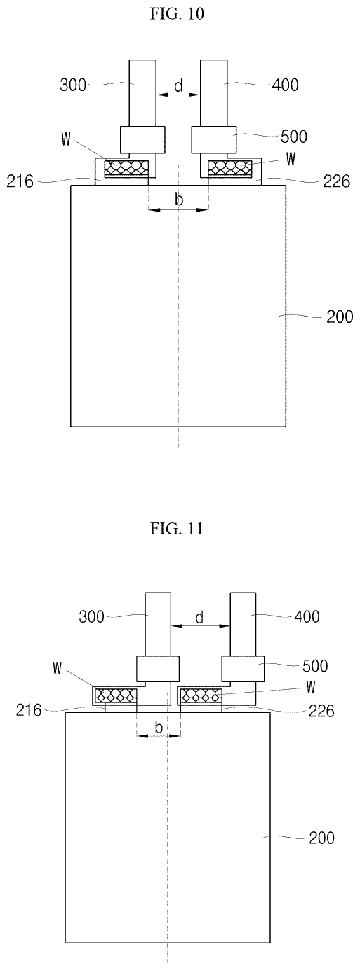

Referring to FIG. 10, the first strip terminal 300 and the second strip terminal 400 may be disposed towards the center of the electrode assembly 200 and positioned symmetrically with respect to a longitudinal center line of the electrode assembly. In this embodiment, the distance d between the first strip terminal 300 and the second strip terminal 400 is the same as in FIG. 8. However, the first bonding part and the second bonding part of the first strip terminal 300 and the second strip terminal 400 may be disposed in opposite directions. Thus, a distance b between the first electrode tab 216 and the second electrode tab 226 is larger than the distance a′ between the electrode tabs 2 and 3 in the example depicted in FIG. 8. In detail, the first bonding part of the first strip terminal 300 is disposed towards a left side in FIG. 10, and the second bonding part of the second strip terminal 400 is disposed towards face a right side in FIG. 10. Even though the distance b between the first electrode tab 216 and the second electrode tab 226 is larger the distance a′ between the electrode tabs 2 and 3 in FIG. 8, the first electrode tab 216 and the second electrode tab 226 may be bonded to the first strip terminal 300 and the second strip terminal 400. And, because the strip terminal is provided with the first bonding part and the second bonding part, there is a wider bonding area than of the bonding area in the example shown in FIG. 8.

Referring to FIG. 11, the first strip terminal 300 and the second strip terminal 400 may be disposed more towards the left or right side of the electrode assembly 200, that is, disposed more towards one side with respect to the longitudinal center line of the electrode assembly. In such an arrangement, the strip terminal adjacent to a left or right end of the electrode assembly 200 may be spaced a predetermined distance from the left or right end of the electrode assembly 200. In specific examples, the spaced distance may be greater than about 2 mm. The distance d between the first strip terminal 300 and the second strip terminal 400 may be designed to be the same as in FIG. 9. However, the first bonding part and the second bonding part of the first strip terminal 300 and the second strip terminal 400 may be extended such that the distance b between the first electrode tab 216 and the second electrode tab 226 is larger than the distance a′ between the electrode tabs 2 and 3 in FIG. 9. In the embodiment depicted in FIG. 11, the first bonding part and the second bonding part of the first strip terminal 300 and the second strip terminal 400 may be disposed to face the left side of the electrode assembly 200. As illustrated, even if the distance between the electrode tabs is greater than in the embodiment depicted in FIG. 9, a length of the strip terminal may be increased to respond to account for a change in bonding position.

As the distance between electrode tabs increases, structural stability, such as the prevention of the short circuit between the terminals, may be improved. In some embodiments, the internal terminal may be disposed to facilitate an electrochemical reaction. The beneficial effects on the electrochemical reaction will be described in more detail.

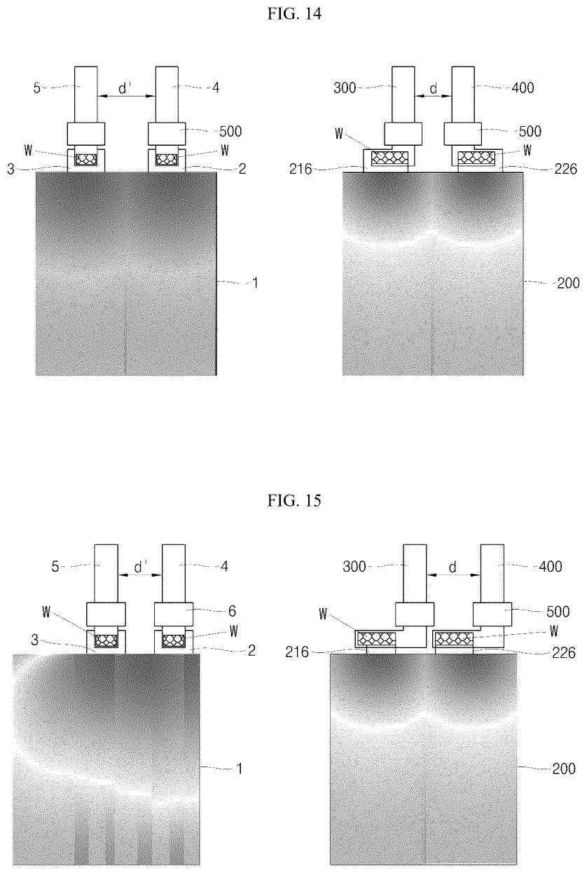

When using a secondary battery for rapid charging or high power, an exothermic state of the secondary battery may be confirmed according to uniformity of the chemical reaction. In FIGS. 14 and 15, a darker color indicates a relatively high temperature, and a lighter color indicates a relatively low temperature.

FIG. 14 illustrates a comparison of the exothermic state of the terminal structure of the typical secondary battery in FIG. 8 and the terminal structure in FIG. 10. In a rapid charging or high power environment in battery configured with the negative electrode tab 2 and the positive electrode tab 3, being a straight shape as illustrated in FIG. 8, a bonding area between the negative electrode strip terminal 4 and the positive electrode strip terminal 5 may be less than that of the terminal structure in battery arrangement shown in FIG. 10. Because the terminal structure in FIG. 10 has a greater bonding area than the bonding area of the terminal structure in FIG. 8, a relatively uniform electrochemical reaction may be induced. That is, the terminal structure in FIG. 10 may cause a relatively uniform exothermic reaction in the electrode assembly 200. And the terminal structure in FIG. 10 is a smaller sized area, on which a relatively high temperature is exhibited, compared to the terminal structure in FIG. 8. Thus, the bonding area between the electrode tab and the strip terminal enable an exothermic control.

FIG. 15 illustrates a comparison of the exothermic state of the terminal structure of the typical secondary battery in FIG. 9 and the terminal structure of the secondary battery depicted in FIG. 11. In a rapid charging or high power environment, the terminal structure illustrated in FIG. 9 may have a bonding area that is less than that of the terminal structure illustrated in FIG. 11. The terminal structure in FIG. 9 results in uneven exothermicity that is concentrated towards one side due to the rapid electrochemical reaction. However, with the terminal structure in FIG. 11, the strip terminals 300 and 400 may be disposed towards one side, but the electrode tabs 216 and 226 are disposed towards the center. Thus, the terminal structure in FIG. 11 may induce the relatively uniform electrochemical reaction compared to the terminal structure in FIG. 9 due to its wide bonding area and central arrangement structure as compared to a one-sided arrangement. Thus, in some embodiments, the exothermicity may be controlled without changing the positions of the strip terminals 300 and 400.

The arrangement of the strip terminals described above may be for embodiments in which the distance between the strip terminals does not vary but the distance between the electrode tabs does vary. However, in other embodiments, the distance between the electrode tabs may vary while the distance between the strip terminals does vary. FIGS. 10, 11 and 12 illustrate examples in which the distance between strip terminals is designed differently in the secondary battery with there being the same distance between the electrode tabs in each of the examples.

Referring to FIG. 10, the first bonding part and the second bonding part of the first strip terminal 300 and the second strip terminal 400 may face in opposite directions. In particular, the first bonding part of the first strip terminal 300 faces a left side in FIG. 10, and the second bonding part of the second strip terminal 400 faces a right side in FIG. 10. The distance d between the first strip terminal 300 and the second strip terminal 400 is less than the distance b between the first electrode tab 216 and the second electrode tab 226.

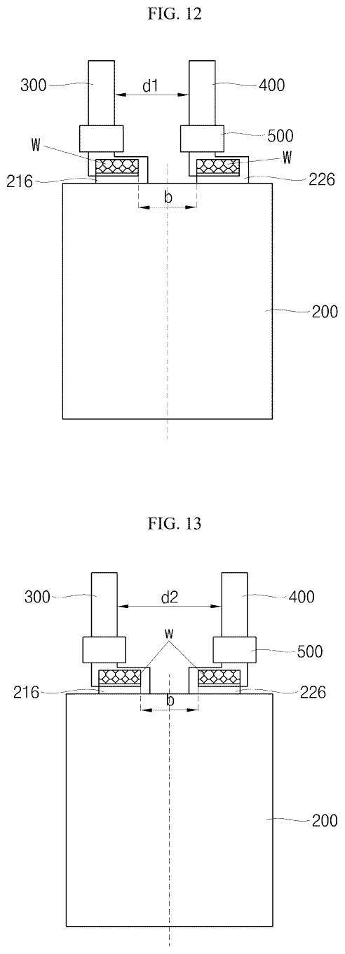

Referring to FIG. 12, the second portions of the first strip terminal 300 and the second strip terminal 400 face the same direction. In particular, the first bonding part and the second bonding part of the first strip terminal 300 and the second strip terminal 400 face the right side in FIG. 12, but the bonding parts may face the left side in other embodiments. In the depicted embodiment, the distance b between the first electrode tab 216 and the second electrode tab 226 may be the same as in FIG. 10. A distance d1 between the first strip terminal 300 and the second strip terminal 400 is greater than the distance b between the first electrode tab 216 and the second electrode tab 226. And the distance d between the first strip terminal 300 and the second strip terminal 400 is longer than that in FIG. 10.

Referring to FIG. 13, the first bonding part and the second bonding part of the first strip terminal 300 and the second strip terminal 400 may be disposed to face each other. In this embodiment, the distance b between the first electrode tab 216 and the second electrode tab 226 is the same as in FIG. 10. A distance d2 between the first strip terminal 300 and the second strip terminal 400 is greater than the distance b between the first electrode tab 216 and the second electrode tab 226. And the distance d2 between the first strip terminal 300 and the second strip terminal 400 is longer than the corresponding distances in FIGS. 10 and 11.

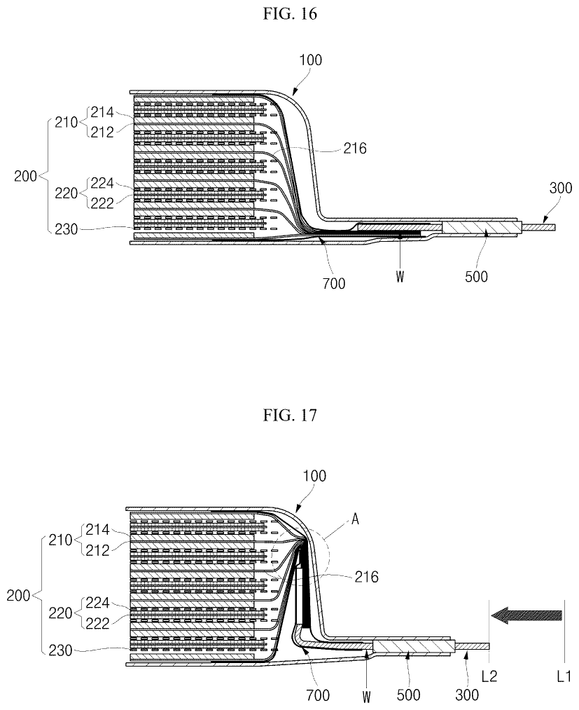

The strip terminal according to various embodiments of the present disclosure may be used in an unbent state after being connected to the electrode tab. Referring to FIG. 16, only the first electrode tab and first strip terminal 300 are illustrated as an example. The electrode tabs 216 may be gathered, integrated, and bonded to the strip terminal 300. Next, an insulating tape 700 may be attached to the outside of the electrode tab 216 and the outside of the bonding area W. Thereafter, with a portion of the strip terminal 300 is exposed to outside of the case 100, the case 100 may be sealed. In some embodiments, in the secondary battery illustrated in FIG. 16, the electrode tab 216, the bonding area W, and the strip terminal 300 may not be bent.

To increase utilization of an internal space in a secondary battery, the strip terminal according to various embodiments of the present disclosure may be used in the bent state. Referring to FIG. 17, the electrode tabs 216 may be gathered, integrated, and bonded to the strip terminal 300, and the insulating tape 700 may be attached to outside of the electrode tab 216 and outside of the bonding area W. Thereafter, each of the electrode tab 216 and the strip terminal 300 may be bent to be compactly accommodated inside the case 100. Next, with a portion of the strip terminal 300 exposed to outside of the case 100, the case 100 may be sealed. In the secondary battery illustrated in FIG. 17, the electrode tab 216 and the strip terminal 300 are bent such that a length of the secondary battery is shorter than an arrangement in which the electrode tab 216 and the strip terminal 300 are not bent (i.e., the length is reduced from L1 to L2). Thus, a volume of the electrode assembly inside the secondary battery may be reduced. And capacity of a battery may accordingly be increased by increasing in size of the secondary battery to extend into the additional space inside of the case provided by bending the electrode tabs and strip terminals.

The L-shaped structure of strip terminal according to the foregoing various embodiments of the present disclosure may provide structural safety to a pouch-type secondary battery. The L-shaped structure may also provide an increased contact area for electrode tabs and resistance may be reduced.

The secondary battery according to the above-described embodiments may be used to manufacture a battery pack. Reference numbers for components described below are reference numbers that are applied only to the corresponding drawings).

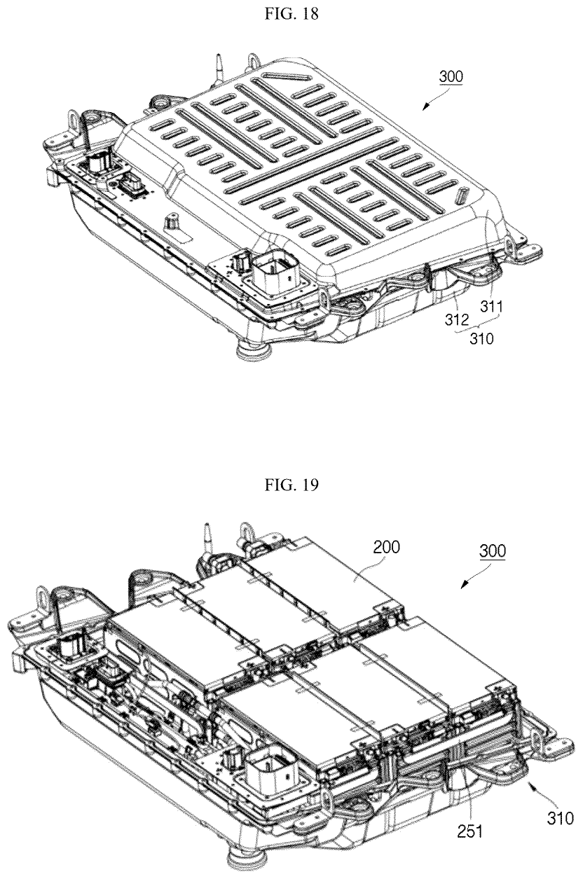

FIGS. 18 and 19 are perspective views showing a battery pack 30000 including an exemplary secondary battery.

Referring to FIGS. 18 and 19, the battery pack 3000 may include a plurality of battery modules 2000 and a housing 3100 for accommodating the plurality of battery modules 2000. For example, the housing 3100 may include first and second housings 3110 and 3120 coupled in opposite directions through the plurality of battery modules 2000. The plurality of battery modules 2000 may be electrically connected to each other by using a bus bar 2510, and the plurality of battery modules 2000 may be electrically connected to each other in a series/parallel or series-parallel mixed method, thereby obtaining desired (e.g., required) electrical output. In the drawings, for convenience, components such as busbars for the electrical connection of battery cells, cooling units, and external terminals are omitted. In some examples, the battery pack (300) may be installed in a vehicle. The vehicle can be, for example, an electric vehicle, a hybrid vehicle, or a plug-in hybrid vehicle. The vehicle may include a four-wheel vehicle or a two-wheel vehicle.

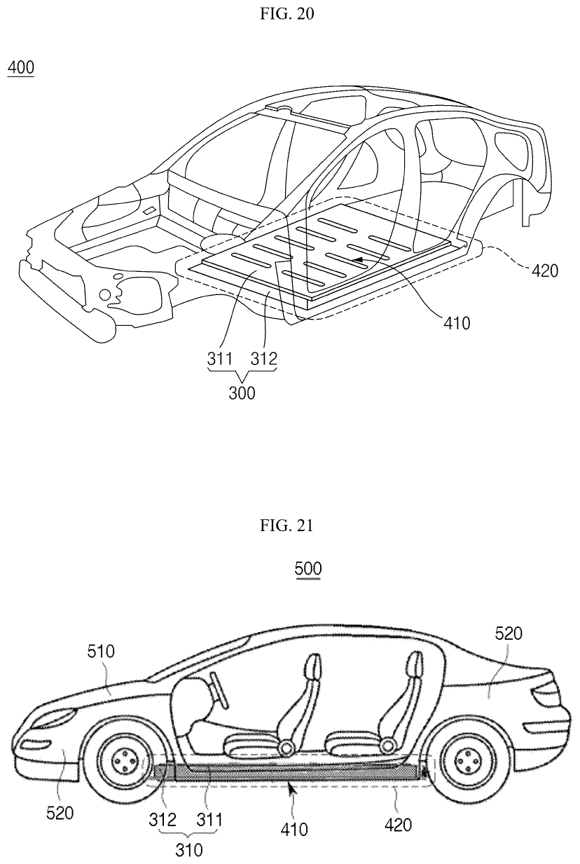

FIGS. 20 and 21 are perspective and side views of automobiles 4000 and 5000 including an exemplary battery pack 3000 according to the present invention. In FIG. 20, a battery pack 3000 may include a battery pack cover 3110, which is a part of a vehicle underbody 4100 and may correspond to the first housing, and a pack frame 3120, which is disposed under the vehicle underbody 4100 and may corresponding to the second housing. The battery pack cover 3110 and the pack frame 3120 may be integrally formed with a vehicle floor 4200. The vehicle underbody 4100 separates the inside and outside of a vehicle, and the pack frame 3120 may be disposed outside the vehicle.

In FIG. 21, a vehicle 5000 may be formed by combining additional parts, such as a hood 5100 in front of the vehicle 5000 and fenders 5200 respectively located in the front and rear of the vehicle 5000 to a vehicle body pars 4000. The vehicle 500 may include the battery pack 3000 including the battery pack cover 3110 and the pack frame 3120, and the battery pack 3000 may be coupled to the vehicle body part 4000.

According to the embodiments of the present disclosure, the position of the internal terminal of the battery cell may be stably designed and fixed and may correspond to changes in positions of external terminals.

According to the embodiments of the present disclosure, the surface area of the connection terminal may be increased as necessary to expand the surface area of the bonding part and reduce the resistance. In some embodiments, the terminal bonding part and the bending area may be separated from each other as necessary to reduce the volume inside the pouch battery. Therefore, a high-capacity battery may be provided.

However, aspects and features of the present disclosure are not limited to those described above, and other aspects and features not mentioned will be clearly understood by a person skilled in the art from the detailed description, described below.

The above-mentioned embodiments are merely examples of the present disclosure, and the present disclosure is not limited to the foregoing embodiments. It will be understood by those of ordinary skill in the art that various changes in form and details may be made therein without departing from the spirit and scope of the present disclosure.

What is claimed is

1. A secondary battery comprising:
a case;
an electrode assembly accommodated in the case, the electrode assembly comprising a stack that includes of first electrode plates each including a first electrode tab, second electrode plates each including a second electrode tab, and separators each of which is interposed between one of the first electrode plates and one of the second electrode plates;
an L-shaped first strip terminal that is bonded to the first electrode tabs, with a portion of the first strip terminal being exposed to outside of the case; and
an L-shaped second strip terminal that is boned to the second electrode tabs with a portion of the second strip terminal being exposed to outside of the case.

2. The secondary battery as claimed in claim 1, wherein the first strip terminal comprises a first bonding part bonded to the first electrode tab and a first extension part extending vertically from the first bonding part, and
wherein the second strip terminal comprises a second bonding part bonded to the second electrode tab and a second extension part extending vertically from the second bonding part.

3. The secondary battery as claimed in claim 2, wherein the first bonding part is disposed perpendicular to a longitudinal direction of the first electrode tab, and
wherein the second bonding part is disposed perpendicular to a longitudinal direction of the second electrode tab.

4. The secondary battery as claimed in claim 3, wherein the first strip terminal and the second strip terminal are symmetrically disposed with respect to a longitudinal center line of the electrode assembly.

5. The secondary battery as claimed in claim 4, wherein the first bonding part and the second bonding part are disposed to face a same direction.

6. The secondary battery as claimed in claim 5, wherein a distance between the first strip terminal and the second strip terminal is greater than a distance between the first electrode tab and the second electrode tab.

7. The secondary battery as claimed in claim 4, wherein the first bonding part and the second bonding part are disposed to face different directions.

8. The secondary battery as claimed in claim 7, wherein a distance between the first strip terminal and the second strip terminal is less than, equal to, or greater than a distance between the first electrode tab and the second electrode tab.

9. The secondary battery as claimed in claim 4, wherein the first bonding part and the second bonding part are disposed to face each other.

10. The secondary battery as claimed in claim 9, wherein a distance between the first strip terminal and the second strip terminal is greater than a distance between the first electrode tab and the second electrode tab.

11. The secondary battery as claimed in claim 3, wherein the first strip terminal and the second strip terminal are disposed more towards one side with respect to a longitudinal center line of the electrode assembly.

12. The secondary battery as claimed in claim 11, wherein, if the first strip terminal and the second strip terminal are biased to the one side with respect to the longitudinal center line of the electrode assembly, a length of each of the first bonding part and the second bonding part is greater than that of each of the first boding part and the second bonding part if the first strip terminal and the second strip terminal are disposed symmetrically with respect to the longitudinal center line of the electrode assembly.

13. The secondary battery as claimed in claim 3, wherein the first bonding part comprises a first surface extending vertically from an end of the first extension part, a second surface parallel to the first surface, and a connection surface connecting the first surface to the second surface, and
wherein the second bonding part comprises a first surface extending vertically from an end of the second extension part, a second surface parallel to the first surface, and a connection surface connecting the first surface to the second surface.

14. The secondary battery as claimed in claim 13, wherein the connection surface is perpendicular to the first surface and the second surface.

15. The secondary battery as claimed in claim 13, wherein the connection surface has a curved shape.

16. The secondary battery as claimed in claim 3, wherein the first bonding part comprises a first surface extending vertically from an end of the first extension part and a second surface facing the first surface, and
wherein the second bonding part comprises a first surface extending vertically from an end of the second extension part and a second surface facing the first surface.

17. The secondary battery as claimed in claim 16, wherein the first surface and the second surface are connected at an acute angle.

18. The secondary battery as claimed in claim 1, wherein the first strip terminal comprises a connection tab bonded to the first electrode tab, and a first extension part disposed perpendicular to the connection tab and coupled to the connection tab, and
wherein the second strip terminal comprises a connection tab bonded to the second electrode tab, and a second extension part disposed perpendicular to the connection tab and coupled to the connection tab.

19. The secondary battery as claimed in claim 18, wherein the connection tab of the first strip terminal and the connection tab of the second terminal each have one of straight, triangular, semicircular, and circular cross-sections.

20. The secondary battery as claimed in claim 1, further comprising insulating member provided in an area between the first strip terminal and the case and an insulating provided in an area between the second strip terminal and the case.
